(19) United States
(12) Patent Application Publication
(10) Pub. No.: US 2016/0034051 A1
(43) Pub. Date: Feb. 4, 2016

(54) AUDIO-VISUAL CONTENT NAVIGATION WITH MOVEMENT OF COMPUTING DEVICE

(71) Applicant: Cisco Technology, Inc., San Jose, CA (US)

(72) Inventors: Benjamin Xi, Suzhou (CN); Doris Qiao, Suzhou (CN); Jojo Jiang, Suzhou (CN); Pinru Cheng, Suzhou (CN)

(21) Appl. No.: 14/448,829

(22) Filed: Jul. 31, 2014

(51) Int. Cl. G06F 3/0346; G06F 3/01; G11B 31/00; G06F 3/0484

(52) U.S. Cl. CPC G06F 3/0346; G06F 3/0484; G06F 3/017; G11B 31/006

(57) ABSTRACT

Methods and apparatus for navigating audio-visual content on a computing device are provided. Embodiments of the system allow a user of the device to navigate the audio-visual content through an application interface using a movement of the device in various directions. A motion detection component built in the device can detect the movement of the device and the detected motion can be translated into one of commands saved in a database. The command causes the application interface to display an updated audio-visual content reflecting the command, which is associated with a particular movement of the device. In some embodiments, the updated audio-visual content can be shared with other computing devices in connection with each other.

### BACKGROUND

1. Technical Field

The present technology pertains to audio-visual content navigation technology in portable computing devices. More particularly, the present disclosure relates to a method for controlling audio-visual content for display with a movement of a portable computing device.

2. Description of Related Art

With dramatic advances in communication technologies, the advent of new techniques and functions in portable computing devices has steadily aroused consumer interest. In addition, various approaches to audio-visual content navigation through user-interfaces have been introduced in the field of portable computing devices.

Many portable computing devices employ touch-screen technology for controlling audio-visual content. Often, touch-screen technology allows a user to directly touch a screen surface through any input tool such as a finger or stylus pen. This often requires two available hands to perform an action, because the user has to hold the device with one hand and use the other hand to give an input on the touch-screen With this technology, there are several disadvantages, such as the fact that a user does not always have two available hands to control a portable computing device, and manipulation of audio-visual content with touch screen technology can cause a user's finger to obscure the manipulated content.

### BRIEF DESCRIPTION OF THE DRAWINGS

In order to describe the manner in which the above-recited and other advantages and features of the disclosure can be obtained, a more specific description of the principles briefly described above will be rendered by reference to specific embodiments thereof, which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIGS. 1A and 1B illustrate an example configuration of a computing device in accordance with various embodiments;

FIG. 2 illustrates a block diagram illustrating an example method for audio-visual content navigation;

FIG. 3 illustrates a process flow diagram representing the steps of controlling the audio-visual content on a computing device in accordance with various embodiments;

FIGS. 4A, 4B, 4C, 4D, 4E, 4F, 4G and 4H illustrate an example configuration of a device movement motion in various directions, in accordance with various embodiments;

FIGS. 5A and 5B illustrate an example interface layout that can be utilized on a computing device in accordance with various embodiments;

FIG. 6 illustrates an example environment where a number of users share the same content on multiple computing devices in accordance with various embodiments; and

FIG. 7 illustrates a process flow diagram that represents the steps of changing an orientation on a screen of a computing device.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

In some embodiments, the present technology is used for manipulating audio-visual content in a portable computing device. This is accomplished, in part, through moving a portable computing device in various directions. In accordance with some embodiments of the disclosure, a movement of the portable computing device is detected. Once the movement is detected, an interpretation of the characteristics of the movement is performed. The interpretation of the characteristics is translated into a command for manipulating playback of the audio-visual content. Accordingly, the manipulation of playback of audio-visual content is enabled.

In some embodiments, the manipulation of playback of audio-visual content includes various ways of controlling audio-visual content, such as: fast-forwarding, rewinding, playing, pausing, stopping, shuffling, skipping, or repeating the audio-visual content. In some embodiments, the manipulation can include increasing/decreasing the volume, changing a channel of the TV, or recording the audio-visual content.

In some embodiments, the manipulation of playback of audio-visual content can be performed on a number of computing devices, which are in communication with each other. A number of computing devices may share the same audio-visual content by designating a “master device” and a “slave device.” The slave device can display an updated audio-visual content as the audio-visual content on the master device is being updated concurrently; the master device has the ability to control the audio-visual content on the slave device. In some embodiments, the role of the master device and the slave device is interchangeable. For instance, a command to manipulate the playback of audio-visual content can be transferred from a master device to a slave device.

Additional features and advantages of the disclosure will be set forth in the description which follows, and, in part, will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

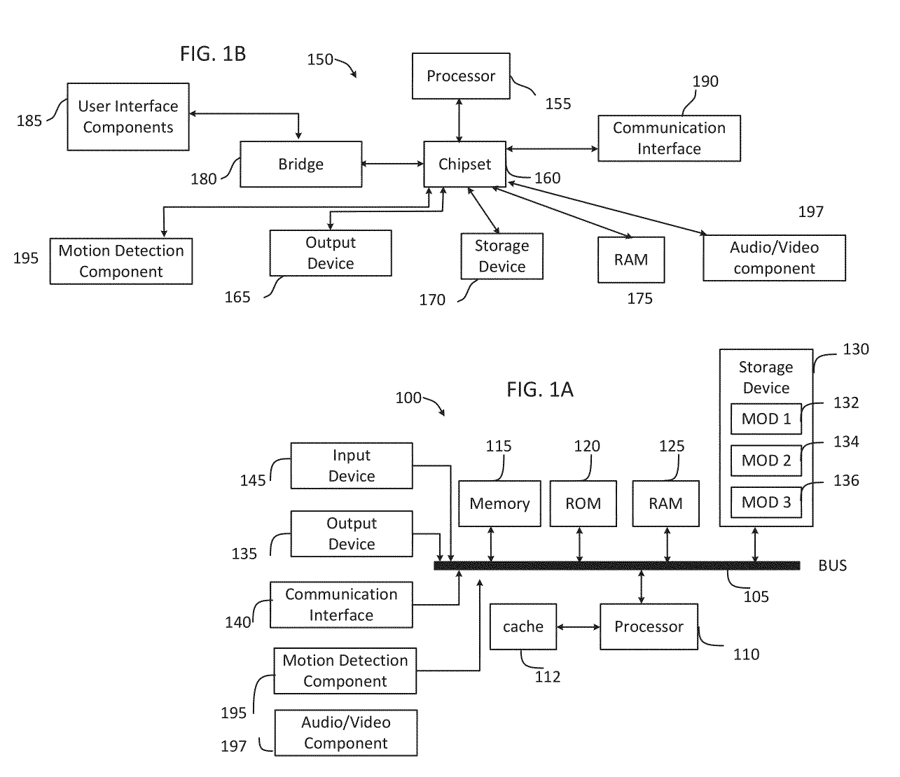

In order to provide various functionalities described herein, FIG. 1A-B illustrate an example set of basic components of a portable computing device 100. Although a portable computing device (e.g. a smart phone, an e-book reader, personal data assistant, or tablet computer) is shown, it should be understood that various other types of electronic device capable of processing input can be used in accordance with various embodiments discussed herein.

FIG. 1A and FIG. 1B illustrate an example configuration of system embodiments. The more appropriate embodiment will be apparent to those of ordinary skill in the art when practicing the present technology. Persons of ordinary skill in the art will also readily appreciate that other system embodiments are possible.

FIG. 1A illustrates conventional system bus computing system architecture 100, wherein the components of the system are in electrical communication with each other using a bus 105. Example system embodiment 100 includes a processing unit (CPU or processor) 110 and a system bus 105 that couples various system components, including the system memory 115—such as read only memory (ROM) 120 and random access memory (RAM) 125—to the processor 110. The system 100 can include a cache of high-speed memory connected directly with, in close proximity to, or integrated as part of the processor 110. The system 100 can copy data from the memory 115 and/or the storage device 130 to the cache 112 for quick access by the processor 110. In this way, the cache can provide a performance boost that avoids processor 110 delays while waiting for data. These and other modules can control or be configured to control the processor 110 to perform various actions. Other system memory 115 may be available for use, as well. The memory 115 can include multiple different types of memory with different performance characteristics. The processor 110 can include any general purpose processor and a hardware module or software module—such as module 1 132, module 2 134, and module 3 136—stored in storage device 130, configured to control the processor 110, as well as a special-purpose processor where software instructions are incorporated into the actual processor design. The processor 110 may essentially be a completely self-contained computing system, containing multiple cores or processors, a bus, memory controller, cache, etc. A multi-core processor may be symmetric or asymmetric.

To enable user interaction with the computing device 100, an input device 145 can represent any number of input mechanisms, such as: a microphone for speech, a touch-sensitive screen for gesture or graphical input, keyboard, mouse, motion input, speech and so forth. An output device 135 can also be one or more of a number of output mechanisms known to those of skill in the art. In some instances, multimodal systems can enable a user to provide multiple types of input to communicate with the computing device 100. The communications interface 140 can generally govern and manage the user input and system output. There is no restriction on operating on any particular hardware arrangement and therefore the basic features here may easily be substituted for improved hardware or firmware arrangements as they are developed.

Storage device 130 is a non-volatile memory and can be a hard disk or other types of computer readable media, which can store data that are accessible by a computer, such as: magnetic cassettes, flash memory cards, solid state memory devices, digital versatile disks, cartridges, random access memories (RAMs) 125, read only memory (ROM) 120, and hybrids thereof.

The storage device 130 can include software modules 132, 134, 136 for controlling the processor 110. Other hardware or software modules are contemplated. The storage device 130 can be connected to the system bus 105. In one aspect, a hardware module that performs a particular function can include the software component stored in a computer-readable medium in connection with the necessary hardware components—such as the processor 110, bus 105, display 135, and so forth—to carry out the function.

In some embodiments the device will include at least one motion detection component 195, such as: electronic gyroscope, accelerometer, inertial sensor, or electronic compass. These components provide information about an orientation of the device, acceleration of the device, and/or information about rotation of the device. The processor 110 utilizes information from the motion detection component 195 to determine an orientation and a movement of the device in accordance with various embodiments. Methods for detecting the movement of the device are well known in the art and as such will not be discussed in detail herein.

In some embodiments, the device can include audio/video components 197 which can be used to deliver audio-visual content to the user. For example, the audio-video components can include: speaker, microphone, video converters, signal transmitter and so on. The audio-video components can deliver audio-visual content which includes audio or video component. The typical audio-video files include: mp3 files, WAV files, MPEG files, AVI files, or WMV files. It should be understood that various other types of audio-video files are capable of being displayed on the device and delivered to the user of the device in accordance with various embodiments discussed herein.

FIG. 1B illustrates a computer system 150 as having a chipset architecture that can be used in executing the described method and generating and displaying a graphical user interface (GUI). Computer system 150 is an example of computer hardware, software, and firmware that can be used to implement the disclosed technology. System 150 can include a processor 155, representative of any number of physically and/or logically distinct resources capable of executing software, firmware, and hardware configured to perform identified computations. Processor 155 can communicate with a chipset 160 that can control input to and output from processor 155. In this example, chipset 160 outputs information to output 165, such as a display, and can read and write information to storage device 170, which can include magnetic media, and solid state media, for example. Chipset 160 can also read data from, and write data to, RAM 175. A bridge 180 for interfacing with a variety of user interface components 185 can be provided for interfacing with chipset 160. Such user interface components 185 can include the following: keyboard, a microphone, touch detection and processing circuitry, a pointing device, such as a mouse, and so on. In general, inputs to system 150 can come from any of a variety of sources, machine generated and/or human generated.

Chipset 160 can also interface with one or more communication interfaces 190 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 155 analyzing data stored in storage 170 or 175. Further, the machine can receive inputs from a user, via user interface components 185, and execute appropriate functions, such as browsing functions, by interpreting these inputs using processor 155.

It can be appreciated that example system embodiments 100 and 150 can have more than one processor 110, or be part of a group or cluster of computing devices networked together to provide greater processing capability.

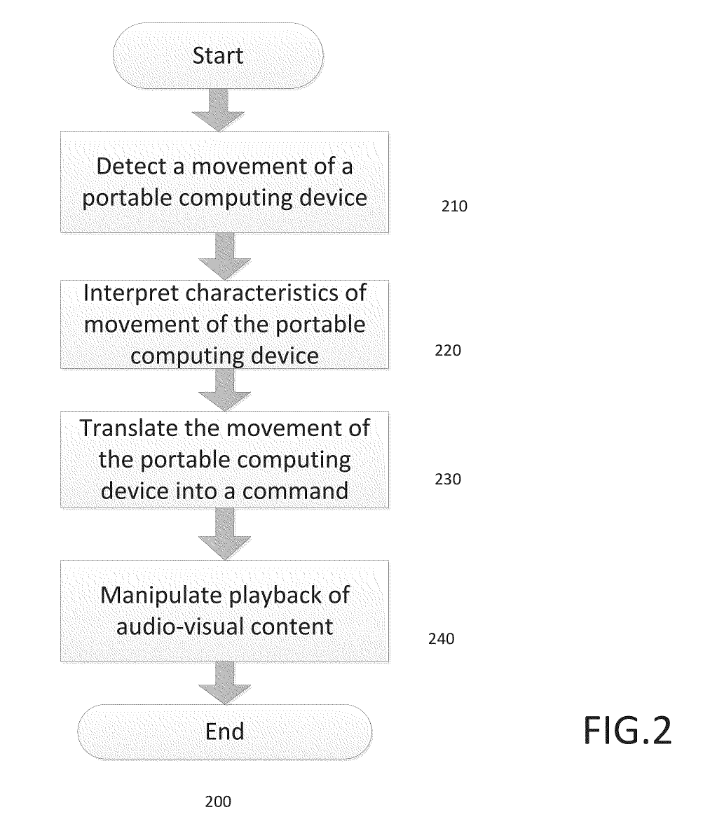

FIG. 2 illustrates an example process 200 for navigating audio-visual content in accordance with various embodiments. It should be understood that, for any process discussed herein, there can be additional or alternative steps performed in similar or alternative orders, or in parallel, within the scope of the various embodiments unless otherwise stated. In some embodiments, a portable computing device is configured to detect various types of movements with respect to the portable computing device 210. These movements can include, for example: tilting, rotating, turning, shaking, snapping, swinging, or moving the computing device in various directions. The movement can be any direction, such as a perpendicular movement to the ground, a parallel movement to the ground, a diagonal movement to the ground, a horizontal movement, or a vertical movement.

The motion detection component 195 is configured to detect and capture the movements by using a gyroscope, accelerometer, or inertial sensor. Various factors such as a speed, acceleration, duration, distance or angle are considered when detecting movements of the device. For example, the rate of the fast-forward or rewind increases when the acceleration, or degree of the movement, increases. For example, if the user accelerates or rotates the device to a first measurement, the application can perform a fast-forward operation, and if the user accelerates or rotates the device to a second measurement, then the audio-visual content can be fast-forwarded twice as fast. More frames of the audio-visual content pass in a given period of time as the rate of the fast-forward increases.

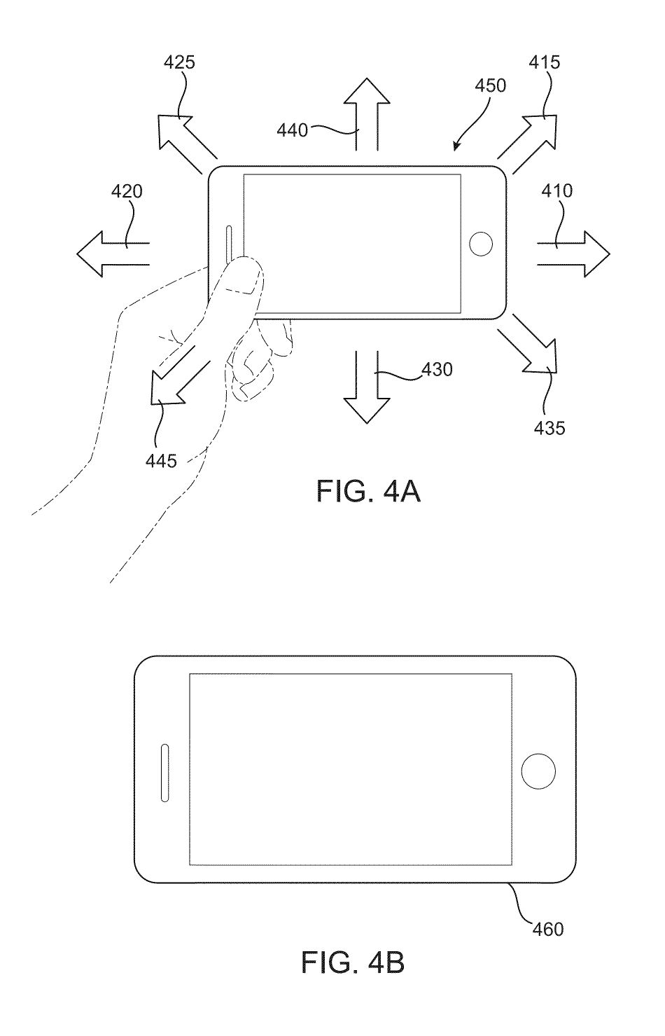

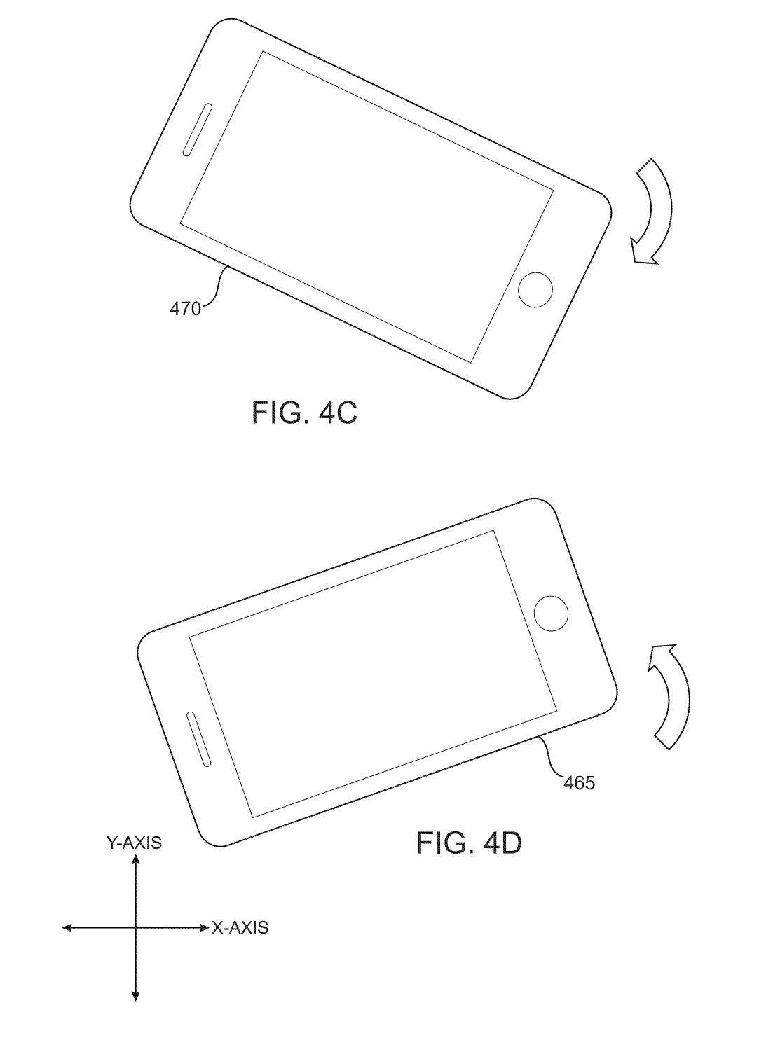

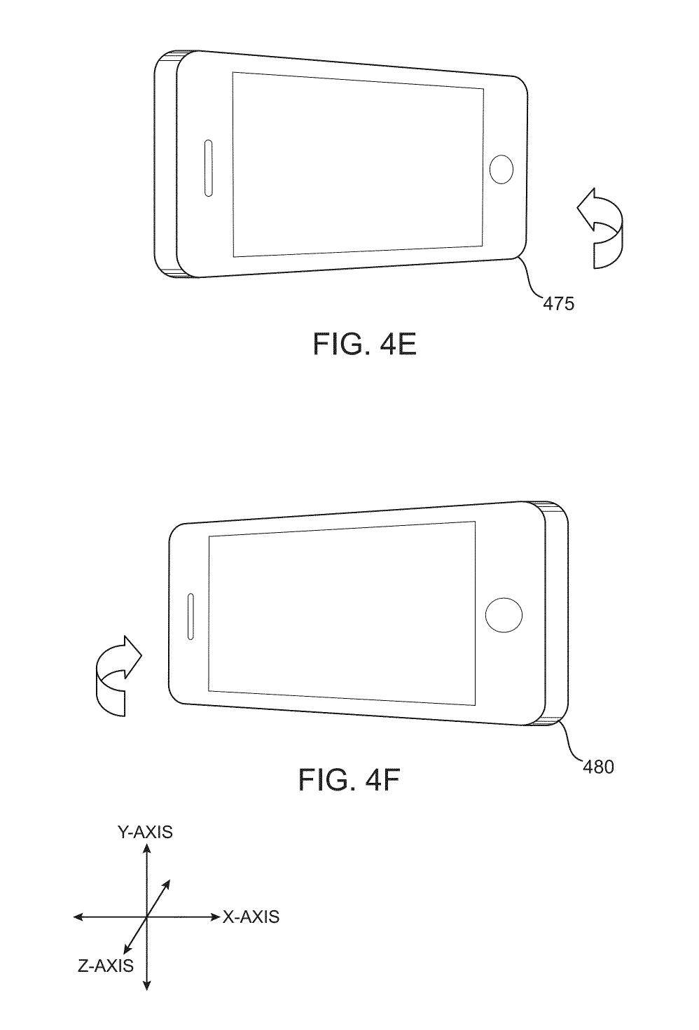

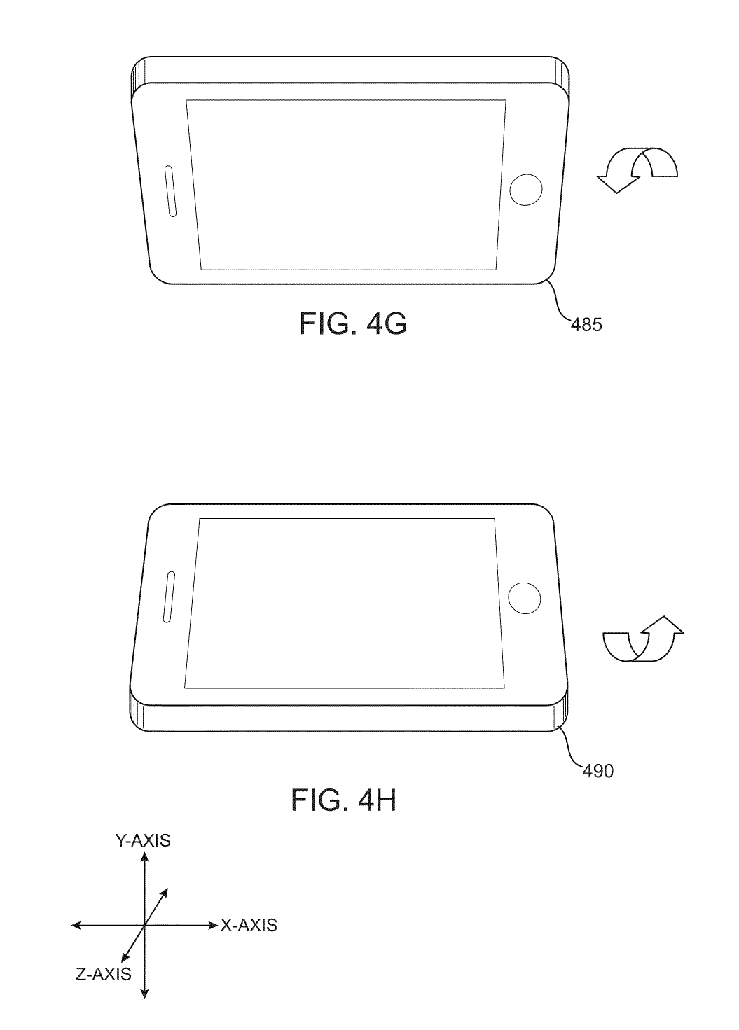

There can be a plurality of movement forms, such as: rotating, tilting, turning, shaking, swinging the device, or, in general, moving the device in various directions, etc. These different types of movement forms can have different characteristics that will each be translated into a different command. For example, rotating the device to a right direction can cause the application interface to translate the movement into a fast-forward command, as shown in FIG. 4E. On the contrary, rotating the device to a left direction can cause the application interface to translate this movement into a rewind command, as illustrated in FIG. 4F. In some embodiments, as shown in FIGS. 4C and 4D, tilting the device can cause the application interface to translate the movement into a volume command.

Moreover, the characteristics of the movement can depend on a number of factors such as a direction, acceleration, or duration of the movement. For example, assuming that a fast-forward command is associated with a movement of the device horizontally to a right direction, then once the device detects a movement to the right direction in relation to the user, it will evaluate a degree of acceleration of the movement to determine an appropriate command and its corresponding action. Likewise, if a skip command is associated with a device movement of a given duration, then the device will evaluate the duration of time that the device is in movement in order to determine an appropriate command and its action.

The computing device can translate the movement into a corresponding command 230. The commands can include, but are not limited to the following: fast-forward, rewind, play, pause, increase volume, decrease volume, record, shuffle, change a channel, or repeat of the audio-visual content. The command associated with a movement in each direction can be predefined in the system. For example, if the user tilts the device clockwise as shown in FIG. 4C, the audio-visual content can be fast-forwarded. In some embodiments, if the user tilts the device counterclockwise as shown in the FIG. 4D, then the audio-visual content can be rewound. If the user rotates the top of the device backwards as shown in FIG. 4H, then the volume of the audio-visual content can be increased. Conversely, if the user rotates the top of the device forward as shown in FIG. 4G, then the volume can be decreased. It should be understood that up, down, right, and left movements are merely examples, and other movements can be performed resulting in various actions in accordance with the various embodiments.

As discussed, the command associated with the movement of the device can enable the application interface to manipulate the audio-visual content 240. Each command corresponding to each movement of the device is applied into the application interface. The application interface can be comprised of a number of menu options which facilitate the user to manipulate the audio-visual content as the user wants. For example, the application interface can be comprised of the following: a volume bar, progress bar, play/pause button, fast-forward/rewind button, activation/inactivation button, and so on. Those buttons in the application interface can communicate with the user to perform an action that the user selects in the application interface. As discussed, different approaches can be implemented in various environments in accordance with the described embodiments.

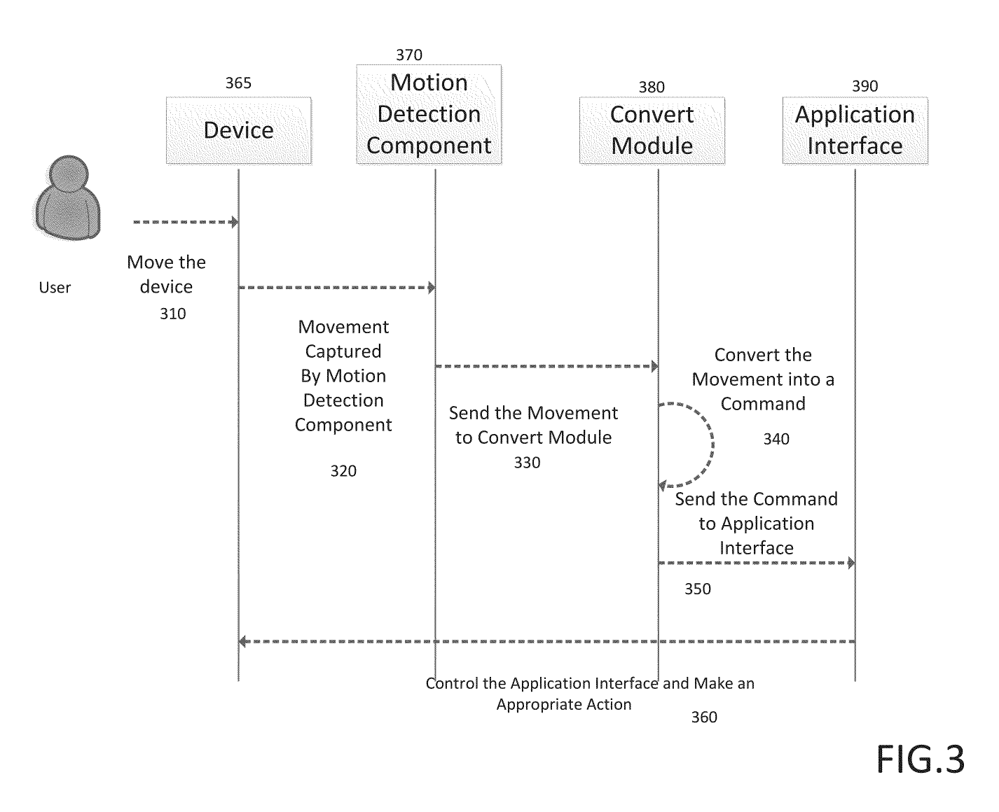

FIG. 3 illustrates a process flow diagram representing the steps of controlling the audio-visual content on the portable computing device 365. As shown, steps performed by the device 365—motion detection component 370, convert module 380, application interface 390—are represented by vertical lines respectively. The user first can move (310) the device in any direction the user wishes. The motion detection component (e.g. gyroscope, accelerometer, inertial sensor, etc.) captures (320) the movement of the device. When the motion component captures the movement, it sends (330) the detected movement to a convert module 380. The convert module 380 can then convert (340) the movement into a command and send (350) the converted command to the application interface. The application interface 390 then makes an appropriate action according to the command (360) and the user can view/hear the audio-visual content manipulated by the application interface 390.

FIG. 4A-4H illustrates an example configuration of a device movement in various directions in accordance with various embodiments. In an operating system, a set of commands corresponding to a set of movements in multiple directions are predefined. The directions can be any direction (410-445) as illustrated in FIG. 4A. In some instances, the functionality corresponding to the direction of the movement of device can be set up by the user in an application interface setting.

For example, as illustrated in FIG. 4A, if the user moves the device 450 in one direction 410, it can enable the application interface 390 to fast-forward an audio-visual content that the user watches. In some embodiments, if the user accelerates or rotates the device in an opposite direction 420, it can enable the application interface 390 to rewind the movie that the user watches. In some embodiments, if the user accelerates or rotates the device to the 440 direction, the volume of the movie can be increased. The volume of the video can be decreased if the user accelerates or rotates the device to the 430 direction. In some embodiments, the user can change the channel of the TV or a video by moving the device in the 425 or 415 directions. The audio-visual content can be shuffled if the user accelerates or rotates the device in the 435 or 445 directions. The movement motion can be any directions, including: perpendicular, vertical, horizontal, or diagonal to the ground. Any operations for controlling the audio-visual content can be associated with any movements in any directions. These arrangements can be made by the user. The depiction of movements or directions should be taken as being illustrative in nature and not limiting to the scope of the disclosure.

In some embodiments, the device can include a tilt adjustment mechanism for controlling the playback of audio-visual content. The tilt adjustment mechanism can adjust playback of audio-visual content based on a tilt direction, angle, duration, or acceleration. The user can cause the audio-visual content to be fast-forwarded or rewound by tilting the device in any direction shown in FIG. 4A. As shown in FIGS. 4B, 4C, and 4D, the user can tilt a non-tilted device 460 clockwise to the 465 position to fast-forward the audio-visual content. On the other hand, the user can tilt the device clockwise to the 470 position to rewind the audio-visual content.

In some embodiments, the device can include a rotation adjustment mechanism for controlling the playback of audio-visual content. The rotation adjustment mechanism can adjust playback of audio-visual content based on a rotation direction. As illustrated in FIG. 4F, the user can rotate the device to the 480 position to skip the audio-visual content. On the contrary, the user can rotate the device to the 475 position to go back to the previous audio-visual content, as illustrated in FIG. 4E. In some embodiments, as shown in FIG. 4G, the user can also rotate the device to the 485 position to increase the volume. On the other hand, the user can rotate the device to the 490 position to decrease the volume, as shown in FIG. 4H. The direction of the rotation, or the operation associated with the direction of the rotation described here, are merely examples of the embodiments, and any association between a movement and a command can be configured.

In some embodiments, the degree of rotation can determine the amount of the audio-visual content to be fast-forwarded or rewound. For example, if the user tilts the device clockwise at an angle of 5 degrees (5°) then the audio-visual content can be fast-forwarded at 1× rate. If the user tilts the device at an angle of 10 degrees (10°), then the audio-visual content can be fast-forwarded at a 2× rate; these are the minimum and maximum baseline levels of rotation that the application interface can be configurable.

In some embodiments, the degree of acceleration can also determine the speed of the fast-forward or rewind. If the user accelerates or rotates the device slowly at the same speed, then the audio-visual content can be fast-forwarded at the same rate. On the other hand, if the user accelerates or rotates the device rapidly in a short period of time, then the audio-visual content can be fast-forwarded quickly in accordance with the degree of acceleration of the movement. This enables the user to manipulate the audio-visual content quickly and without a long movement of the device.

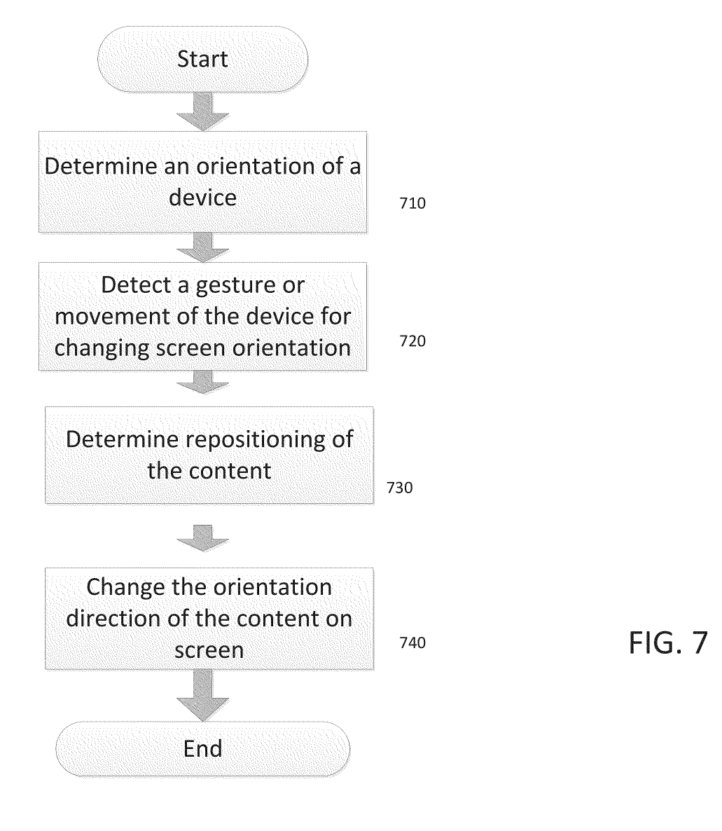

In many situations, the application interface can recognize an orientation setting of the device. For example, moving the device horizontally to the right on a landscape orientation would be recognized as moving the device vertically downwards if the device is on a portrait orientation. To avoid this confusion, the application interface can recognize an orientation presented on the device 710. The orientation can depend on the way the user holds the device, but the user can manually change the orientation setting in the application interface 390 by locking a screen rotation function. As shown in FIG. 7, the application interface 390 can detect a gesture or movement made by the user to change the screen orientation 720. The application interface 390 interprets the input made on the device in relation to the current orientation of the screen; the interface then determines the repositioning of the audio-visual content on the screen 730. The application interface 390 can change the orientation direction of the audio-visual content based on the repositioning of the audio-visual content 740.

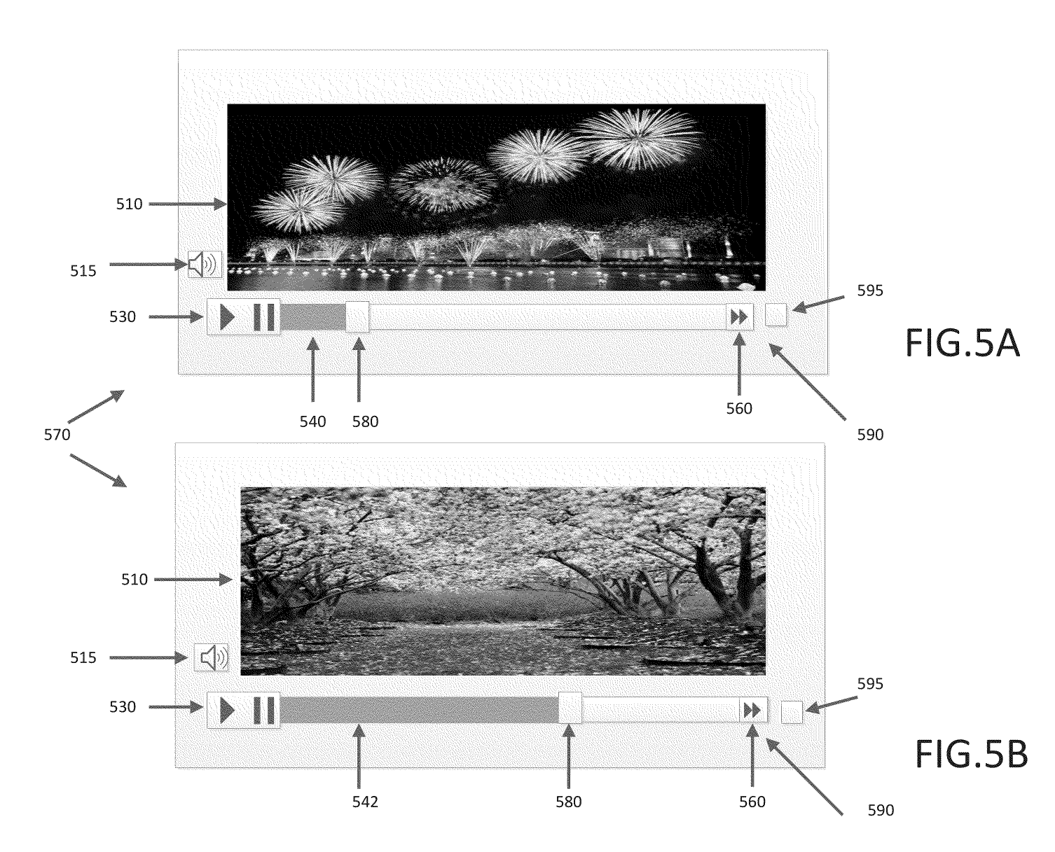

FIGS. 5A and 5B illustrate interface layout that can be utilized on a computing device in accordance with various embodiments. The portable computing device 570 includes a display screen 510 that displays audio-visual content, which includes a sound or video component. In some embodiments, the application interface 390 can comprise a progress bar 590 to show a progression status of the audio-visual content. The progress bar includes a status indicator 580, which shows a current progression status of the audio-visual content. The status indicator 580 is directly proportional to an amount of audio-visual content that has been played 540, 542 from an entire amount of audio-visual content.

As illustrated by FIGS. 5A and 5B, the status indicator 580 (FIG. 5A) shows that the amount of audio-visual content that has been played 540 in FIG. 5A is different from the amount of audio-visual content played 542 in FIG. 5B. FIG. 5B reflects a status after the command has been performed. Accordingly, the display screen 510 reflects an updated audio-visual content as a result of the command caused by the movement of the device. In some embodiments, a volume icon 515 which indicates a current volume level can be displayed on the progress bar. In some embodiments, a channel list bar indicative of the current audio-visual content among other audio-visual contents available to the device can be displayed in the progress bar.

The progress bar 590 also includes a play/pause button 530, which enables the user to play or stop the audio-visual content as necessary. The progress bar 590 also includes a fast-forward/rewind button 560 to fast-forward or rewind the audio-visual content as necessary. In some embodiments, the audio-visual content can be played or paused by tapping a play/pause button 530, or by a movement of the device that triggers a play/pause command. Subsequently, the user can make a second movement of the device to further enable the device to perform a different action, such as fast-forwarding or rewinding. In some embodiments, the user can also simply click, tap, touch the fast-forward or rewind button 560 to execute the same action.

In some embodiments, the user can control a speed rate of fast-forward or rewind operation. For example, the application interface 390 can receive the first and second input simultaneously from the user. The user can move the device (first input) and click the fast-forward/rewind button 560 (second input) simultaneously. Subsequently, the user can stop moving the device, but still hold the fast-forward/rewind button 560; the fast-forward or rewind operation can still be performed even if the user does not move the device anymore, because a movement which triggers the fast-forward/rewind operation has already been detected. In some embodiments, for example, holding the fast-forward/rewind button for 2 seconds can trigger the application interface 390 to fast-forward the audio-visual content four times faster than a baseline speed. In another example, holding the fast-forward/rewind button for 3 seconds can trigger the application interface 390 to fast-forward the content eight times faster than a baseline speed. The speed rate of fast-forward or rewind of the audio-visual content can be based on a period of time over which the user holds the fast-forward/rewind button 560. The time period required for such operation can be later changed in an application interface 390 setting. Once the user un-touches the fast-forward/rewind button 560, then the application interface 390 can start to play the updated audio-visual content.

The application interface also can include a volume icon 515. A volume can also be controlled based on a time period over which a first input is received on the device. For instance, the application interface 390 can receive a first input—a movement of the device—and a second input—receiving a tap on the volume icon 515 from the user—simultaneously. Subsequently, the user can release the second input on the volume icon 515 but still be able to move the device to increase or decrease the volume. For example, the volume is increased 1% every 100 milliseconds until the first input is not received on the device anymore. Thus, to increase the volume by 50%, the user can simply tap the volume button and move the device, release the tap button, but still move the device for 5 seconds.

In some embodiments, an activation/inactivation button 595 can be highlighted when the user activates the fast-forward/rewind operation by either moving the device or giving an input on the activation/inactivation button 595; this can be accomplished by clicking, tapping, or touching the activation/inactivation button 595. For example, if the user is on a bumpy bus ride, then that could cause the device to move left and right regardless of the user's intention. The user would not want the motion detection component 195 to detect movement that the user did not initiate. In that case, this activation/inactivation button 595 can be used to lock the motion detection component. The motion detection component 195 will only detect the movement of the device when it is being activated by the user. Likewise, the activation/inactivation button can be used to unlock the motion detection component 195 if the user wants to initiate the movement. After the motion detection component 195 is activated and the user moves the device to make a desired action, the user can simply inactivate the motion detection component 195 by again clicking, tapping, or touching the same activation/inactivation button 595. The activation/inactivation button 595 can be highlighted when the user clicks the button. The highlighted color for activation and inactivation functions can be different, so the user is able to identify which function is being selected.

The progress bar 590 can be enlarged when the device receives an input from the user. In some instances, the user can tap the device to enlarge the progress bar for a larger view. Thus, the status bar can be gradually shifted for a sophisticated manipulation. When the progress bar is enlarged, it can overlap with the audio-visual content. The audio-visual content can be deemed for a better view of the progress bar as the progress bar is being enlarged.

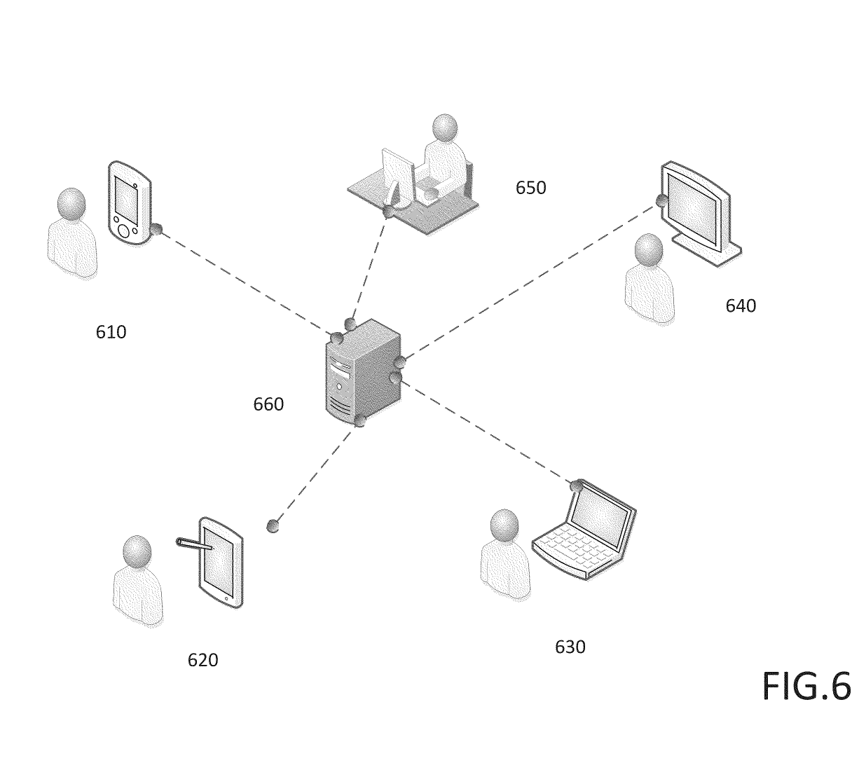

FIG. 6 illustrates an example environment where other users share the same audio-visual content on their computing devices 610-650 in accordance with various embodiments. The illustrative environment includes at least one main application server 660 and a multiple number of computing devices 610-650, connected through the main application server 660. It should be understood that there can be several application servers, layers, or other elements, processes or components, which can interact with each other to perform tasks such as sharing the audio-visual content. The main application server 660 can include any appropriate hardware and software for integrating multiple computing devices 610-650 as needed to execute application interface 390 on the multiple computing devices to share the audio-visual content. Each server will typically include an operating system that provides executable program instructions for an operation of that server and computer-readable medium storing instructions.

Computing devices 610-650 can include a number of general purpose personal computers, such as: desktop or laptop, display devices, TV, monitor, cellular, wireless or handheld devices running an application interface 390. The computing devices can also include any portable computing devices such as a smart phone, an e-book reader, personal data assistant, or tablet computer. The environment can be an interconnected computing environment utilizing several systems and components that enable the computing devices to communicate via the following: links, internet, Bluetooth, networks, or direct connection. Also, a distance between multiple computing devices is not limited, as long as a connection between the computing devices is available. Methods for connecting the computing devices remotely are well known in the art and as such will not be discussed in detail herein.

An advantage of various embodiments is the ability to share the same audio-visual content among multiple computing devices without individual members manipulating their own devices. In many instances, the user of each device will want to view the same audio-visual content without each user navigating the same audio-visual content on their own devices. For example, if a first user of a first device 610 accelerates or rotates the first device to navigate the audio-visual content on the first device, the second user of the second device in connection with first device can then watch the same audio-visual content on the second device. For example, the first user with the first device 610 (e.g. smartphone) on a sofa can manipulate playback of the audio-visual content to watch a certain portion of the audio-visual content that the first user is interested watching, then the second user on his or her own device 640 (e.g. user of TV) on the sofa in a same room can watch the same portion of the audio-visual content without getting up from the sofa or using a remote controller to control the TV. It would be more convenient for the user of a portable computing device to control the audio-visual content by simply moving the portable computing device, rather than the user of the TV who sits far away from the TV, making this feature advantageous for the user. The first user can perform any action to control the audio-visual content on the first device, and the audio-visual content on the second device can be updated as the first user's audio-visual content is updated.

Such embodiment can benefit users of computing devices in a conference meeting setting. For example, when the first user 610 manipulates the audio-visual content of the meeting material on the first device, the second user of computing device 640 in the same room can view the same meeting material on the second computing device. This can be beneficial to the second user who is merely following the first user's lead on the meeting material, but who still wants to view the meeting material on his/her own device. For instance, if the first user controls a slideshow on the first device by snapping the first device, then the second device can display an updated slideshow on the second device. The first user can snap the device quickly to the right to go to a next slide or snap the device to the left to go back to the previous slide. Controlling a slideshow using the portable computing device can be convenient in a presentation setting, so that the presenter can maintain his position without approaching to his laptop to control the slideshow.

As discussed above, the first user can control the audio-visual content displayed on the second device. In such case, the first device can be a master device and second device can be a slave device. The master device has the ability to control what is displayed on the slave device. The master device can be determined by a possession of a controller. The device with the controller can be the master device. The controller can be provided to a master device by requesting the controller in the application interface 390. The user of the slave device can approve of the master device's control of the audio-visual content on the slave device by accepting an invitation sent by the master device. The user of the master device can deliver the controller to a different user of slave device in the application interface 390. The slave device that receives and accepts the controller can be a next master device, and can perform any actions provided to the master device. The slave device user can view which device possesses a controller in their application interface 390s and can decide whether they will accept the invitation from the master device. The application interface 390 of the master device can indicate that this device is the master device and respective functions provided to the master device.

Any device in the network can see how many devices are connected in the network and can invite other devices that are not in the network to join the network in order to share the audio-visual content. Conversely, other devices that are not part of the network can also send a request to join the network to any of the devices in the network. The master device can also request a lock on the network and make the network a limited network that is not available or viewable to other devices. Any slave device that wishes to be disconnected from the network can simply leave the network unless it is not permitted by the master device otherwise.

For clarity of explanation, in some instances the present technology may be presented as including individual functional blocks, including: functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as: energy, carrier signals, electromagnetic waves, and signals per se.

Methods according to the above-described examples can be implemented using computer-executable instructions that are stored or otherwise available from computer-readable media. Such instructions can include, for example, instructions and data which cause or otherwise configure a general purpose computer, special purpose computer, or special purpose processing device to perform a certain function or group of functions. Portions of computer resources used can be accessible over a network. The computer-executable instructions may be, for example: binaries, intermediate format instructions such as assembly language, firmware, or source code. Examples of computer-readable media that may be used to store instructions, information used, and/or information created during methods according to described examples include: magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include: laptops, smart phones, small form factor personal computers, personal digital assistants, and so on. Functionality described herein can also be embodied in peripherals or add-in cards. Such functionality can also be implemented on a circuit board among different chips or different processes executed by in a single device, by way of further example.

The instructions, media for conveying such instructions, computing resources for executing them, and other structures for supporting such computing resources are means for providing the functions described in these disclosures.

Although a variety of examples and other information were used to explain aspects within the scope of the appended claims, no limitation of the claims should be implied based on particular features or arrangements in such examples, as one of ordinary skill would be able to use these examples to derive a wide variety of implementations. Furthermore, although some subject matter may have been described in language specific to examples of structural features and/or method steps, it is to be understood that the subject matter defined in the appended claims is not necessarily limited to these described features or acts. For example, such functionality can be distributed differently, or performed in components other than those identified herein. Rather, the described features and steps are disclosed as examples of components of systems and methods within the scope of the appended claims.

1. A computer implemented method comprising:
detecting a first input on a first computing device, the first computing device being a portable computing device, the first input being a first movement of the portable computing device;
interpreting characteristics of the first input of the portable computing device;
translating the first input of the portable computing device into a command for manipulating playback of audio-visual content; and
manipulating playback of audio-visual content according to the command.

2. The method of claim 1, further comprising:
receiving a second input, the second input in conjunction with the first input causes an application interface to perform operations corresponding to the command associated with the first input and second input.

3. The method of claim 1, wherein the first movement comprises a movement of the portable computing device in a first direction, the movement is detected by a motion detection component built in the portable computing device.

4. The method of claim 1, wherein manipulating playback of audio-visual content further comprises manipulating playback of audio-visual content on a second computing device, the second computing device is configured to display a same audio-visual content displayed on the first computing device.

5. The method of claim 4, wherein the first computing device and the second computing device are configured to be remotely connected.

6. The method of claim 4, wherein the motion detection component is configured to determine a latitudinal and longitudinal coordinate of the first input being received on the first computing device.

7. The method of claim 1, further comprising:
applying the command into the application interface executed on the screen of the first computing device, causing the application interface to display an updated audio-visual content corresponding to the command associated with the first input.

8. The method of claim 1, wherein the command for manipulating playback of audio-visual content is comprised of the following: a fast-forward command, a rewind command, a play command, a pause command, a volume command, a record command, a shuffle command, a channel change command, or a repeat command of the audio-visual content.

9. The method of claim 1, wherein a rate of fast forward or rewind of the audio-visual content is correlated to a period of time over which the second input is received.

10. The method of claim 9, wherein the first input is no longer received while the second input is still being received, and a motion for the second input is static on the screen.

11. The method of claim 9, wherein a distance the first computing device moves in relation to the longitudinal and latitudinal coordinate of the first input is correlated to the rate of the fast forward or rewind of the audio-visual content.

12. A computing device comprising:
a device processor;
a display screen; and
a memory device including instructions that, when executed by the device processor, enable the computing device to:
detect a first input on a first computing device, the first computing device being a portable computing device, the first input being a first movement of the portable computing device;
interpret characteristics of the first input of the portable computing device;
translate the first input of the portable computing device into a command for manipulating playback of audio-visual content; and
manipulate playback of audio-visual content according to the command.

13. The computing device of claim 12, wherein the instructions when executed further enable the computing device to:
receive a second input, the second input in conjunction with the first input causes an application interface to perform operations corresponding to the command associated with the first input and second input.

14. The computing device of claim 12, wherein the first movement comprises a movement of the first computing device in a first direction, the movement is detected by a motion detection component built in the first computing device.

15. The computing device of claim 12, wherein the duration of the second input received on the first computing device is correlated to a rate of fast-forward or rewind of the audio-visual content.

16. The computing device of claim 12, wherein the duration of the first movement on the first computing device is correlated to the rate of fast-forward or rewind of the audio-visual content.

17. A non-transitory, computer-readable storage medium including instructions that, when executed by a processor of a portable computing device, cause the computing device to:
detect an input on the portable computing device, the input being a movement of the portable computing device;
interpret characteristics of the input of the portable computing device;
translate the input of the portable computing device into a command for manipulating playback of audio-visual content; and
manipulate playback of audio-visual content according to the command.

18. The non-transitory computer-readable storage medium of claim 17, wherein a degree of acceleration of the movement is correlated to a rate of fast-forward or rewind of the audio-visual content.

19. The non-transitory computer-readable storage medium of claim 17, wherein a degree of rotation of the portable computing device is correlated to the rate of the fast forward or rewind of the audio-visual content.

20. The non-transitory computer-readable storage medium of claim 17, wherein the movement of the portable computing device comprises tilting, turning, shaking, snapping, or swinging the portable computing device.
